(19) United States
(12) Patent Application Publication
(10) Pub. No.: US 2002/0069247 A1
(43) Pub. Date: Jun. 6, 2002

(54) Business network platform method and system

(76) Inventors: Daryoush Paknad, Palo Alto, CA (US); Reza Roodsari, San Jose, CA (US); Peter Lin, Foster City, CA (US)

Correspondence Address: Alan S. Hodes, Morrison & Foerster LLP, 755 Page Mill Road, Palo Alto, CA, 94304-1018, US

(21) Appl. No.: 09/823,719

(22) Filed: Mar. 30, 2001

Related U.S. Application Data
(60) Provisional application No. 60/212,385, filed on Jun. 14, 2000.

(51) Int. Cl. G06F 15/16

(52) U.S. Cl. 709/204; 709/218; 709/203

(57) ABSTRACT

A method and system is provided for creating and managing a network of electronic collaboration sites.

### RELATED APPLICATIONS

The present application is related to U.S. Provisional Application No. 60/212,385, filed Jun. 14, 2000. This application also is related to U.S. Application Ser. No. 09/627,532, filed on Jul. 28, 2000.

### TECHNICAL FIELD

The present invention relates to a system and method for managing data over a network, and more particularly to creating and managing a network of electronic collaboration sites.

### BACKGROUND ART

Problems presently exist when business users presently attempt to collaborate on various projects with their external constituents. Business users typically attempt to use the telephone, Federal Express and other mail services, and electronic mail when attempting to collaborate. However, when multiple persons attempt to work on project or document, problems can occur, for example, with version control. In addition, business users have difficulty managing multiple work relationships and the specific content that various users are viewing. With teams of, for example, hundreds of people, it is difficult to communicate with all of them efficiently. In addition, security problems arise when businesses attempt to collaborate on files or documents.

Web sites presently exist that attempt to help users access content. For example, Yahoo.com is a publishing site that allows users to upload content and is tailored toward helping end-users find content. Some personalization is also possible with end users having the capability to selectively view information. Nevertheless, the previously mentioned problems for business users attempting to collaborate still exist. Accordingly, what is desired is an improved, centralized system and method for electronic collaboration with business partners over a network such as the Internet without requiring the business partner to install a software package.

### SUMMARY OF THE INVENTION

The present invention provides a system and method for creating and managing an electronic network of collaboration sites.

In one aspect of the invention, a method and system is provided for creating an object that is a software representation of a collaboration site or node by communicating site design choices for display to a user, receiving a selection of site designs choices, communicating information channel choices to the user, and receiving a selection of information channel choices.

In a further aspect of the invention, the object may be a node or a site, such as a private client site that may be a child or subnode of the collaboration site.

In another aspect of the invention, a data structure is provided, wherein the data structure includes an identification field associated with a user. The identification field may include a user name and a location associated with the user. The location may be associated with an object that may represent a collaboration site or node. In a further aspect of the invention, the data structure may be associated with a global user table.

In another aspect of the invention, a method and system is provided for creating an object by receiving user information, creating a name associated with the object, communicating a choice of one or more user interfaces, receiving a selection of one of the one or more user interfaces, communicating a set of one or more feature choices, and receiving a selection associated with at least one of the one or more feature choices.

### BRIEF DESCRIPTION OF THE DRAWINGS

FIG. 1 shows an exemplary overview of an embodiment of the system and method of the present invention.

FIG. 2 shows an exemplary architecture overview associated with an embodiment of the system and method of the present invention.

FIG. 3 shows an exemplary flowchart overview associated with an embodiment of the invention.

FIG. 4 shows an exemplary view of a Main Server associated with an embodiment of the system and method of the present invention.

FIG. 5 shows an exemplary view of a BNode object for an embodiment of the system and method of the present invention.

FIG. 6 shows an overview of a database associated with an embodiment of the system and method of the present invention.

FIG. 7 shows an exemplary screenshot associated with a template selection screen for an embodiment of the present invention.

FIG. 8 shows an exemplary screenshot of an information channel selection screen associated with an embodiment of the system and method of the present invention.

FIG. 9 shows a logo and intranet naming screen of an embodiment of the system and method of the present invention.

FIG. 10 shows an exemplary client name and logo screen associated with an embodiment of the system and method of the present invention.

FIG. 11 shows an exemplary screenshot of an add clients to private client site screen associated with an embodiment of the system and method of the present invention.

FIG. 12 shows an exemplary screenshot of a group management screen associated with an embodiment of the system and method of the present invention.

FIG. 13 shows an exemplary screenshot of a user group management screen associated with an embodiment of the present invention.

FIG. 14 shows an exemplary view of a directory permissions screen associated with an embodiment of the present invention.

FIG. 15 shows an exemplary screenshot of an intranet folder 1500 associated with a view of an exemplary document repository for an embodiment of the present invention.

FIGS. 16A and 16B show an exemplary view of an object hierarchy for an embodiment of the system and method of the present invention.

FIG. 17 shows an exemplary view of pointer array data structures associated with an embodiment of the system and method of the present invention.

FIG. 18 shows an exemplary view of a global user table associated with an embodiment of the system and method of the present invention.

### DETAILED DESCRIPTION OF THE PREFERRED EMBODIMENT

The present invention provides a method and apparatus for creating and managing a network of collaboration sites. In the following description, numerous details are set forth in order to enable a thorough understanding of the present invention. However, it will be understood by those of ordinary skill in the art that these specific details are not required in order to practice the invention. Further, well-known elements, devices, process steps and the like are not set forth in detail in order to avoid obscuring the present invention.

Although the invention has been described in conjunction with particular embodiments, it will be appreciated that various modifications and alterations may be made by those skilled in the art without departing from the spirit and scope of the invention. The-invention is not to be limited by the foregoing illustrative details, but rather is to be defined by the appended claims.

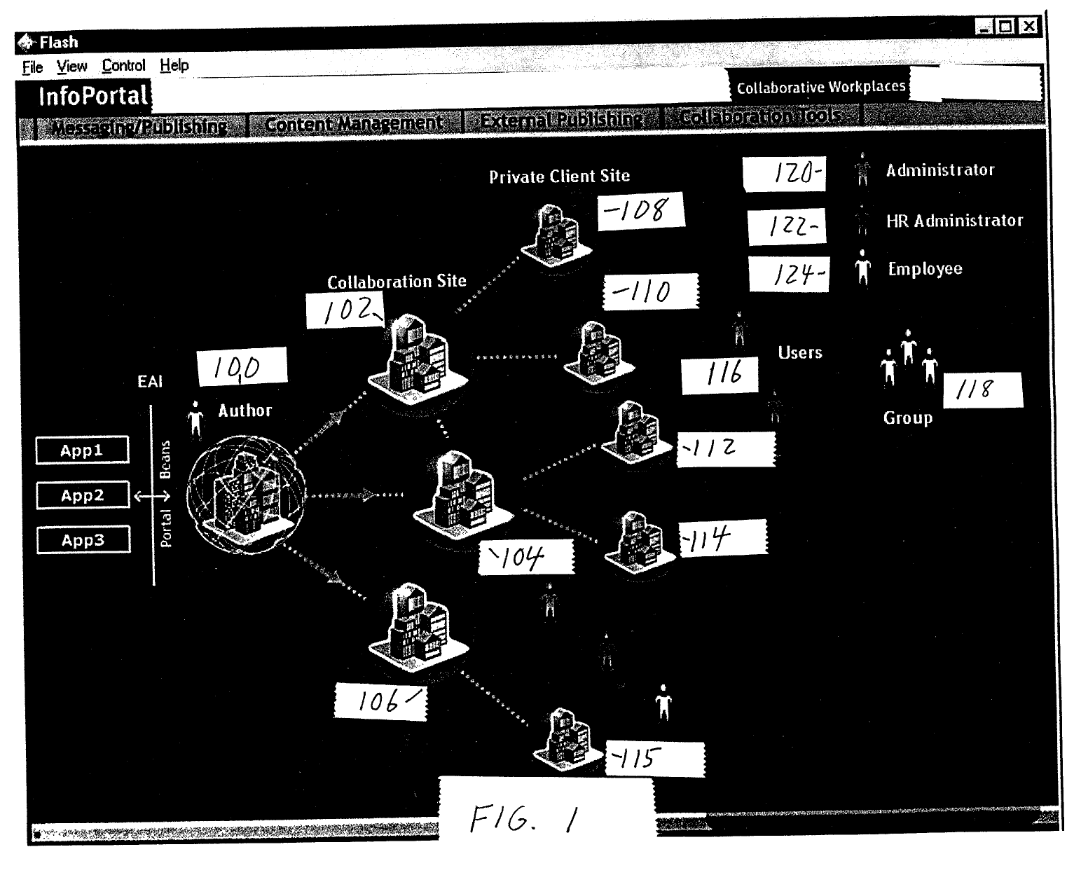

FIG. 1 shows an exemplary overview of an embodiment of the system and method of the present invention. In an embodiment of the invention, Author Site 100, Collaboration Sites 102, 104, and 106, and Private Client Sites 108, 110, 112, 114, and 115 may each be, for example, an object, a node, or a site. For example, each object 100, 102, 104, 106, 108, 110, 112, 114, and 115 maybe a business node. In an exemplary embodiment of the invention, each object 100, 102, 104, 106, 108, 110, 112, 114, and 115 may communicate content, such as but not limited to files, folders, documents, email, instant messages, notifications, database records, links, information channels, and information channel content, to other objects 100,102,104,106,108, 110,112,114, and 115. In an embodiment of the invention, Users 116 of each object 100, 102, 104, 106, 108, 110, 112, 114, and 115 may include Administrators 120, HR Administrators 122, Employees 124, and other users, such as external users. In an embodiment, Groups of Users 118 may also access each object 100, 102, 104, 106, 108, 110, 112, 114, and 115.

In an exemplary embodiment, each object 100, 102, 104, 106, 108, 110, 112, 114, and 115 may be a department, a business unit, a group, or a subgroup. In an embodiment of the invention, objects 102, 104, and 106 may be subnodes of object 100, and object 100 may be a parent node of objects 102, 104, 106, 108, 110, 112, 114, and 115. For example, objects 108 and 110 may be subnodes of object 102.

In an embodiment of the invention, a subnode, such as but not limited to object 108, 110, may inherit information from a parent node, such as but not limited to object 102, associated with the subnode 108, 110. The inherited information may include information channels. For example, information channels may include buckets of information and content, such as but not limited to files, folders, documents, emails, instant messages, notifications, database records, and links. In an exemplary embodiment, an information channel may be set as optional or mandatory. For example, a user, such as an owner, creator, or administrator of a subnode, may decide whether to inherit or subscribe to optional information channels but may be required, for example, to inherit or subscribe to mandatory information channels.

In an exemplary embodiment of the invention, groups of users may be added as users of any object 100, 102, 104, 106, 108, 110, 112, 114, and 115. For example, a group of users may be associated with a sales department, a marketing department, a support department, an engineering department, or another department.

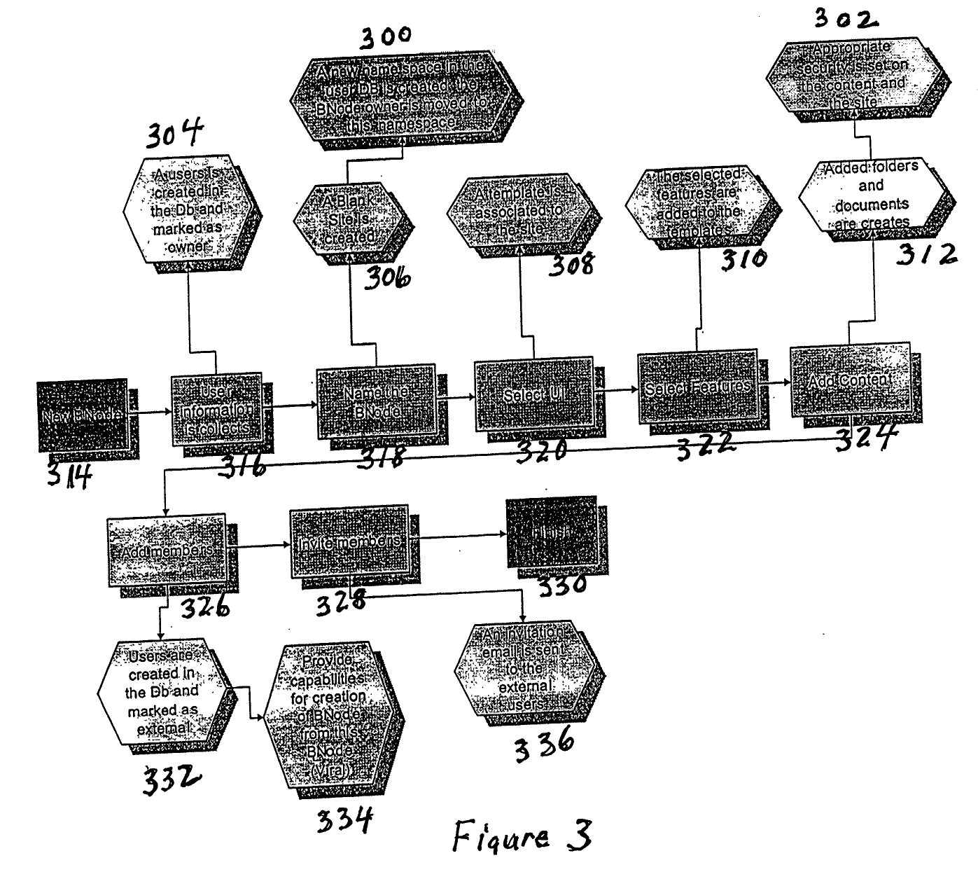

FIG. 3 shows an exemplary flowchart overview of an embodiment of the invention. In step 314, a user at a personal computer attempts to create an object associated with an embodiment of the invention. This object may be, for example, a business node (BNode), a collaboration site, or a private client site. This node or site may be connected to other nodes or sites, for example through connected URLs. In an embodiment of the invention, each node, for instance, may be a low level C++ object in the system of an embodiment of the invention.

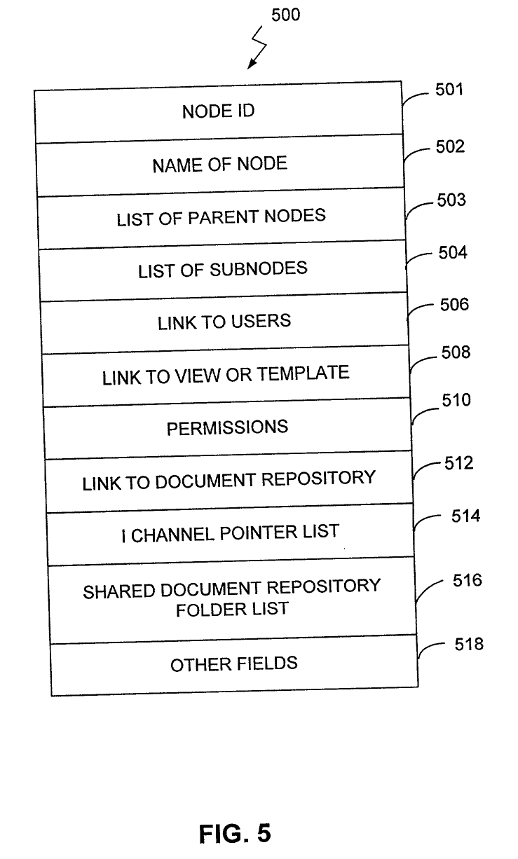

An object created in step 314, such as a node, site, or BNode object, may contain information stored in fields. FIG. 5 shows an exemplary view of a BNode object 500. In an embodiment of the invention, BNode object 500 may include fields such as Node ID 501, Name of Node 502, List of Parent Nodes 503, List of Subnodes 504, Link to Users 506, Link to View or Template 508, Permissions 510, Link to Document Repository 512, I Channel Pointer List 514, Shared Document Repository Folder List 516, and Other Fields 518.

Node ID 501 may be a unique number that identifies the node or object within the system of an embodiment of the invention. In an embodiment of the invention, Node ID 501 may be, for example, a 32-bit number which is a unique number within a database of the system. Name of Node 502 may include a name for the node. Name of Node 502 may be, for example, an alphanumeric character string up to, for example, 2 k bits that may be selected by the owner of the node when the owner creates the node.

List of Parent Nodes 503 may include a list of parent nodes that are linked to or associated with the node. In an embodiment of the invention, List of Parent Nodes 503 may include, for example, an array of links or pointers to other Node IDs or object IDs of parent nodes that are linked to or associated with the node.

List of Subnodes 504 may include a list of subnodes that are linked to or associated with the node. In an embodiment of the invention, List of Subnodes 504 may include, for example, an array of links or pointers to other subnode Node IDs or object IDs of subnodes that are linked to or associated with the node.

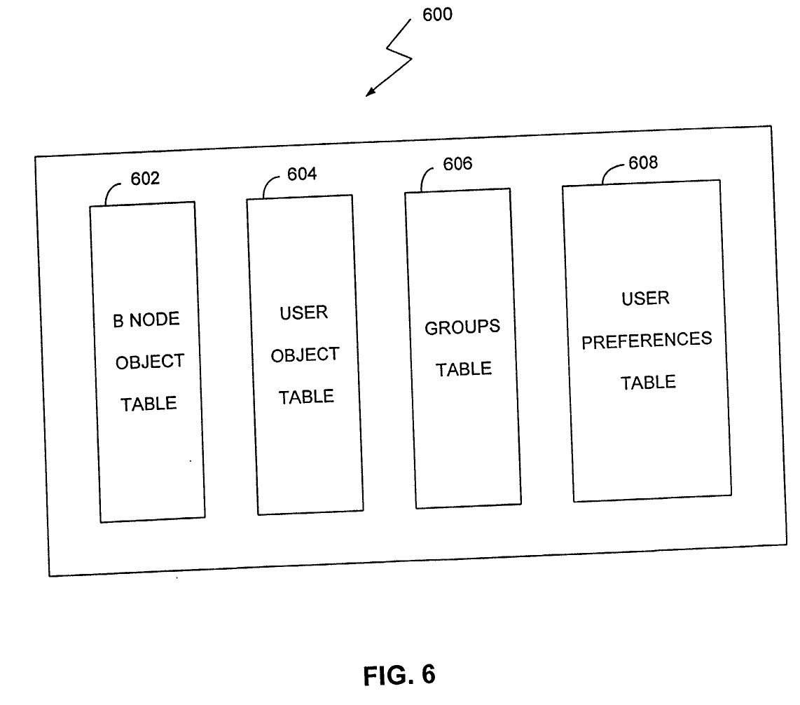

Link to Users 506 may include information describing a set of users that have access to the node or can log on to the node. In an embodiment of the invention, Link to Users 506 may include an array of pointers that point to users within a user object table, such as but not limited to User Object Table 604 in FIG. 6. Link to Users 506 may include an array that is of variable size and may grow dynamically as additional users are added to or associated with the node or object. In an embodiment of the invention, Link to Users 506 may include pointers to groups of users, such as but not limited to user groups associated with Groups Table 606 in FIG. 6.

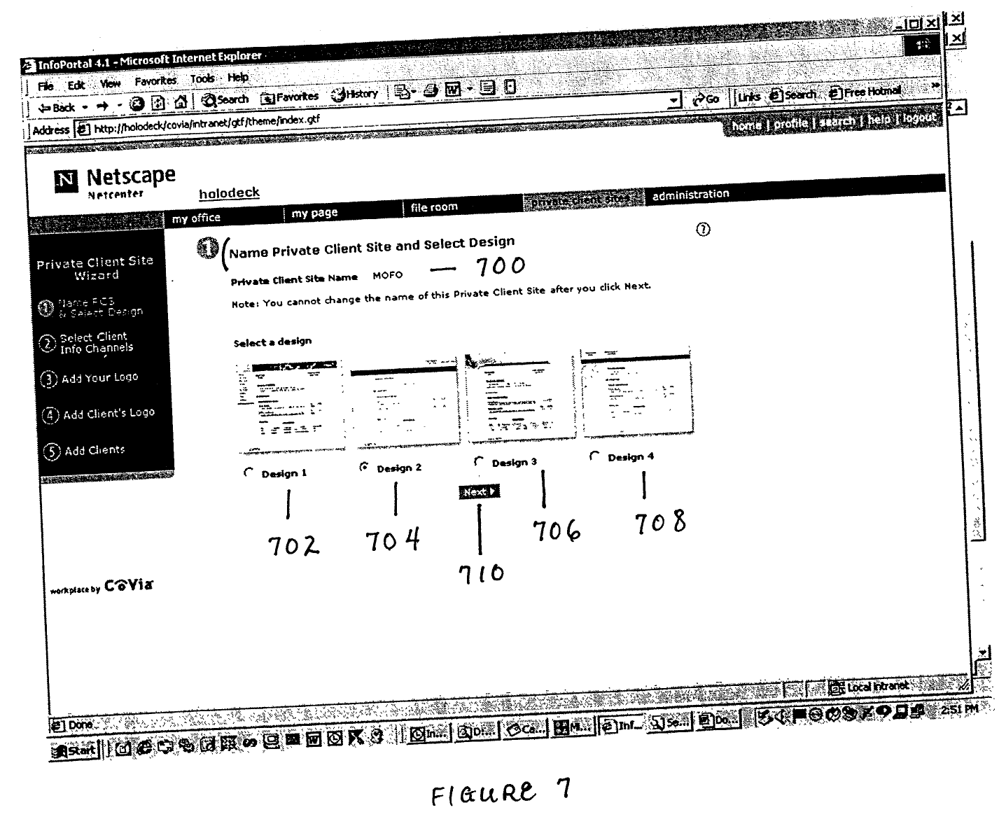

In an embodiment of the invention, referring again to FIG. 5, Link to View or Template 508 may include a link to a view or a template associated with a visual display to be communicated to the user. Link to View or Template 508 may include, for example, an array of a pointer to a visual template or design selected by the user in the exemplary screenshot in FIG. 7.

In an embodiment of the invention, when a user logs on to a node or object, the system of an embodiment of the invention retrieves preferences for the node, including user preferences and a template for the node. In an embodiment of the invention, the template for the node may include a script that is executed when the user interact with or logs on to the system.

The following is an exemplary portion of the script for an embodiment of the invention. It will be appreciated by one of ordinary skill in the art that the following script is exemplary in nature and may be written in different ways to achieve the goals of the script.

index1.gtf
$()[]$[use_module(“/jscore/feature/f_acctauth.js”); CVAcctAuth(IU); //

Allow only site admins users to view this page try { var o = new OSTREAM;
o.append(‘ ’); write(o.toString());} catch(e) {service,rollback(e); } ]

mycomc1.gtf
$<auth>()[]
$<nocache>
$<gsjs>[
try{
use_module(“/covia/intranet/js/1/1_myintranet.js”);
use_module(“/covia/intranet/js/1/1_bodywrapper.js”);
var/*class*/1 = new 1_myintranet();
//var r = bodywrapper(1.renderNewContent());
//temporarily render the testing page with all the Dynamic IChannel

created and deployed to Intranet My Office page

var r = bodywrapper(1.renderContent());
write(r);
}
catch (e) {

service.rollback(e);

}
]
myintranetb1.gtf
$<auth>()[]
$<gsjs>[
try {

var o = new OSTREAM;
o. append(‘

<frameset cols=“160,*” border=0>

<frame

name=“CV_Menu”
src=“mycomm.gtf”
marginwidth=“0”
marginheight=“0”
border=0
frameborder=0
scrolling=“no”
noresize>

<frame

name=“CV_Content”
scr=“mycomc.gtf”
marginwidth=“0”
marginheight=“0”
border=0
frameborder=0
scrolling=auto
noresize>

</frameset>’);
write(o.toString());
}
catch (e) {

service.rollback(e);

}
]

l _myintranet1.js

function /*string*/ 1_myintranet_RenderMenu()
{

use_module(“../t/t_menu.js”);
use_module(“/jscore/tools/t_config.js”);
var /*t_config*/ tc = new t_config();
var bWebMail = tc.GetConfigBool(“Features”, “WebMail”);
var bCalendar = tc.GetConfigBool(“Features”, “Calendar”);
var bCollaborate = tc.GetConfigBool(“Features”, “Collaborate”);
var bTeamChat = tc.GetConfigBool(“Features”, “TeamChat”);
var cvmailscrp = “document.webmaillogin.submit();”;
var calendarurl = “/covia/intranet/gtf/calendar/”;
var actionitemurl = “/covia/shared/gtf/actionitems/actionitems .gtf”
var contactsurl =

“/covia/shared/gtf/contacts/contacts.gtf?whichcontactstoshow=my_contacts”;

var discurl = “/covia/shared/discussion/listtopics.gtf”;
var employeedir = “/covia/intranet/gtf/theme/udirectory.gtf”;
var o = new OSTREAM;
o.append(‘

<body topmargin=0 leftmargin=0 rightmargin=0 marginwidth=0

marginheight=0 link=“#333366” alink=“#333366” vlink=“#333366”
bgcolor=white>’);

var /*string[]*/ MenuData = new Array();
if (bWebMail) {

| // Get the webmail menu | |
|---|---|
| MenuData[MenuData.length] = | |
| new Array(false, “webmail”, | “#”, |

| | |
|---|---|
| cvmailscrp, | “CV_Content”); |

// Webmail need a invisible form which needs current user and its

mailbox info

use_module(“/jscore/obj/o_user.js”);
use_module(“/jscore/feature/f_usermgr.js”);
var /*o_user*/ u = CVCurrentLoginUser();
var f_umgr = new f_usermgr();
var mailbox = f_umgr.GetCPMailboxName(u);
o.append(‘

<form name=webmaillogin method=post action=“http://mail.covia.com”

target=“CV_Body”><input type=“hidden” name=“login” value=“Email”><input
type=“hidden” name=“userlogin” value=“‘+mailbox+’”><input type=“hidden”
name=“password” value=’, dquote(htmlify(u.GetProperty(“User::_password”))),
‘></form>

```
’);
  }
  if(bCalendar) {
```

| MenuData[MenuData.length] = | | |
|---|---|---|
| new Array(false, “calendar”, | calendarurl, | null, |

```
“CV_Content”);
  }
  /*
  if (bCollaborate)
```

MenuData[MenuData.length] = new Array(false, “calendar”,

| | | |
|---|---|---|
| calendarurl, | null, | “CV_Content”); |

if (bTeamChat)

MenuData[MenuData.length] = new Array(false, “calendar”,

| | | |
|---|---|---|
| calendarurl, | null, | “CV_Content”); |

```
  */
  MenuData[MenuData.length] =
```

new Array(false, “my_action_items”, actionitemurl, null,

```
  “CV_Content”);
  MenuData[MenuData.length] =
```

| | |
|---|---|
| new Array(false, “contact_list”, contactsurl, | null, |

“CV_Content”);

MenuData[MenuData.length] =

new Array(false, “new_discussion”,discurl, null,

“CV_Content”);

MenuData[MenuData.length] =

| | |
|---|---|
| new Array(false, “user_listing”, employeedir, | null, |

“CV_Content”);

o.append(‘

<script>’);

CommonMenuScript(o, MenuData, this.thememgr.Color(“imgroot”));
o.append(‘

</script>
<table cellPadding=0 cellSpacing=0 border=0 width=100% height=100%

bgcolor=white>

<tr>

<td valign=top>

<table cellPadding=0 cellSpacing=0 border=0 width=100%

bgcolor=white>

<tr>

<td valign=top><img src=’,

this.thememgr.ImgSrc(“menu_spacer”), ‘border=0></td>

</tr>’);

var /*p_intranet_theme*/ p = this.thememgr;
var /*string*/ themeroot = p.Color(“imgroot”);
/* Internet search removed from ‘My Office.*/
// var /*string[]*/ Menu = new

Array(“webmail”,“calendar”,“my_action_items”,“contact_list”,“new_discussion”,
“collaborate”,“teamchat”,“user_listing”);

for (var i=0; i<MenuData.length; i++)
{
var is_separator = MenuData[i][0];
var mname = MenuData[i][1];
var mlink = MenuData[i][2];
var mscrp = MenuData[i][3];
var mtarg = MenuData[i][4];
var imglink = themeroot + mname + “.gif”
var stuff= “”;
if (is_separator)

stuff = MakeSeparator(mname, imglink);

else

stuff = MakeLink(mname, imglink, mlink, mscrp, mtarg, 145,

15);

o.append(‘

<tr>

<td valign=top>‘, stuff, ’</td>

</tr>’);

}
o.append(‘

<tr>

<td valign=top><img src=’,

this.thememgr.ImgSrc(“menu_spacer”), ‘ border=0></td>

</tr>
<tr>

<td valign=top><img src=’,

this.thememgr.ImgSrc(“bottomnav”), ‘ border=0></td>

</tr>

</table>

</td>

</tr>
<tr>

<td height=* valign=bottom bgcolor=white>

&nbsp;

</td>

</tr>
<tr><td valign=bottom>
‘, this.renderFooter(), ’</td>
</tr>

```
  </table>
  </body>
```

‘);
return o.toString();

```
  }
  function /*string*/ 1_myintranet_RenderContent()
  {
```

use_module(“/jscore/tools/t_msgservice.js”);
use_module(“/jscore/pref/p_msgservice.js”);
use_module(“/jscore/tools/t_iclfilter.js”);
use_module(“/jscore/obj/o_user.js”);
use_module(“/jscore/feature/f_acctsvc.js”);
use_module(“1_ftr.js”);
use_module(“/covia/intranet/js/p/p_intranet_theme.js”);
use_module(“/jscore/tools/t_ftr.js”);
var /*p_intranet_theme*/ themeMgr = new p_intranet_theme();
// find out the climbing list by using f_acctsvc's getMainAlias
var /*o_user*/ u = CVCurrentLoginUser();
var /*f_acctsvc*/ fa = new f_acctsvc();
var /*o_userbsae[]*/ uarra = fa.getMainAlias(u);
var /*o_icl[]*/ uic = CVTMSGGetICL(uarra);
use_module(“/jscore/tools/t_icschema.js”);
var o = new OSTREAM();
uic = ICLViewable(uic);
// filter for the global and intranet icl
uic = CVFilterICLByUserType(uic, (new Array(CTYPE_INTRANET,

CTYPE_ALL)));

var /*o_icl[]*/ page_icl = ICLPage(“01”, uic);
// set the order to the actiavte order if this is the first time rendering
var ftrloid_arr = new Array;
var temporder = CVGetFeatureOrder(u);
if (temporder.length == 0) {

for (i=0; i<page_icl.length; i++)

ftrloid_arr[i] = page_icl[i].ftrLoid;

CVSetFeatureOrder(u, ftrloid_arr);

}
//bug 7625 fix to width=400
o.append(‘
<table cellPadding=0 cellSpacing=0 border=0 bordercolor=red

width=600 bgcolor=white>

<tr><td nowrap><img src=‘+themeMgr.ImgSrc(“clear”)+’ border=0

width=10></td></tr>

<tr>’);
o.append(‘<td valign=top>’);
var /*o_icl[]*/ area_icl= ICLArea(“02”, page_icl);
// get the user ic display order
area_icl = CVGetUserOrderIC(u, area_icl); // get the icl[]based on

user's display order

for(var i=0; i<area_icl.length; i++)
{

if(area_icl[i])

o.append(CVLFTRDrawFeature(area_icl[i]));

}
o.append(‘</td><td><img src=‘+themeMgr.ImgSrc(“clear”)+’ border=0

width=8></td>’);

o.append(‘<td valign=top>’);
var /*o_icl[]*/ area_icl= ICLArea(“03”, page_icl);
area_icl = CVGetUserOrderIC(u, area_icl); // get the icl[] based on

user's display order

for(var i=0; i<area_icl.length; i++)
{

if(area_icl[i])

o.append(CVLFTRDrawFeature(area_icl[i]));

}
o.append(‘</td><td><img src=‘+themeMgr.ImgSrc(“clear”)+’ border=0

width=8></td>’);

o.append(‘<td valign=top>’);
var /*o_icl[]*/ area_icl= ICLArea(“04”, page_icl);
area_icl = CVGetUserOrderIC(u, area_icl); // get the icl[]based on

user's display order

for(var i=0; i<area_icl.length; i++)
{
if(area_icl[i])

o.append(CVLFTRDrawFeature(area_icl[i]));

```
  }
  o.append(‘</td>’);
  o.append(‘
```

</tr>
</table>’);

```
return o.toString();
}
function /*class*/ 1_myintranet() {
  use_module(“/covia/intranet/js/1/1_intranetpage.js”);
  use_base(this, new 1_intranetpage());
  this.renderMenu = 1_myintranet_RenderMenu;
  this.renderContent = 1_myintranet_RenderContent;
}
```

In an embodiment of the invention, referring again to FIG. 5, Link to View or Template 508 may include a pointer to one of the templates or scripts. In an embodiment of the invention, when the script is executed, the results of the executed script may be displayed to the user when the user logs onto the site or node. In an embodiment of the invention, the user profile interface may change dynamically.

In an exemplary embodiment of the invention, the script may cause an embodiment of the system and method of the present invention to retrieve information from the user profile, which may be stored in, for example, the User Preferences Table 608 in FIG. 6.

Referring again to FIG. 5, in an embodiment, Permissions 510 may include information describing a list of users that have permission to view the node, along with a list of users, such as but not limited to the owner and administrators, that are permitted to modify the node. Permissions 510 may also include, for example, a pointer to an administrator group for the node. In an embodiment of the invention, the administrator group may be stored in the database. In an embodiment of the invention, the owner and administrators may have full access to modify and read the object, whereas site users may receive read-only access to the object. In an embodiment of the invention, the owner and administrators

Link to Document Repository 512 may include information related to a link to a document repository associated with the node. In an embodiment of the invention, Link to Document Repository 512 may include a pointer to a location of the document repository, for example, an alphanumeric character string associated with the folder location of the document repository in a hard drive, database, or URL associated with an embodiment of the system and method of the present invention. In an exemplary embodiment of the invention, the document repository may be stored on a database associated with an embodiment of the system and method of the present invention. In another embodiment of the invention, the document repository may be located on a hard drive associated with a user computer or PC.

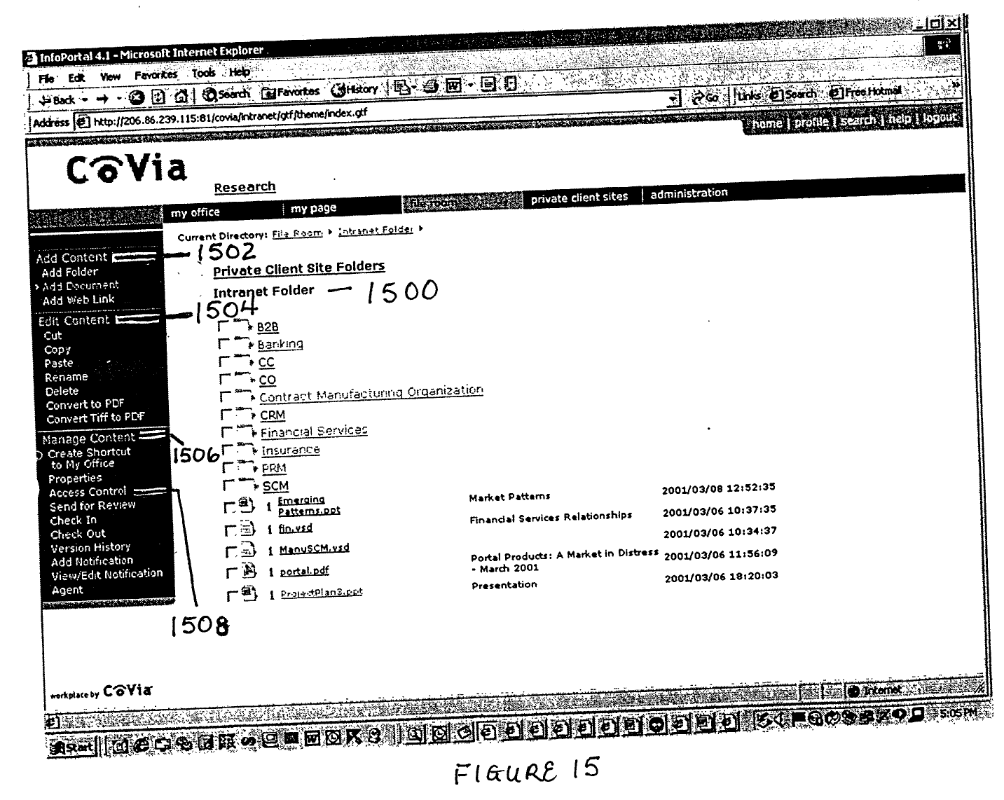

In an embodiment of the invention, after a user logs onto the site, the user may upload documents and content to the site, which may be stored in the document repository. The document repository may also contain, for instance, documents and other content otherwise associated with the node. FIG. 15 shows an exemplary screenshot of an intranet folder 1500 associated with a view of an exemplary document repository. In an embodiment of the invention, a user may click or select links to Add Content 1502, Edit Content 1504, and Manage Content 1506. For example, the user may set different security levels for each uploaded document or content, such as allowing other users read-only access to the document or content.

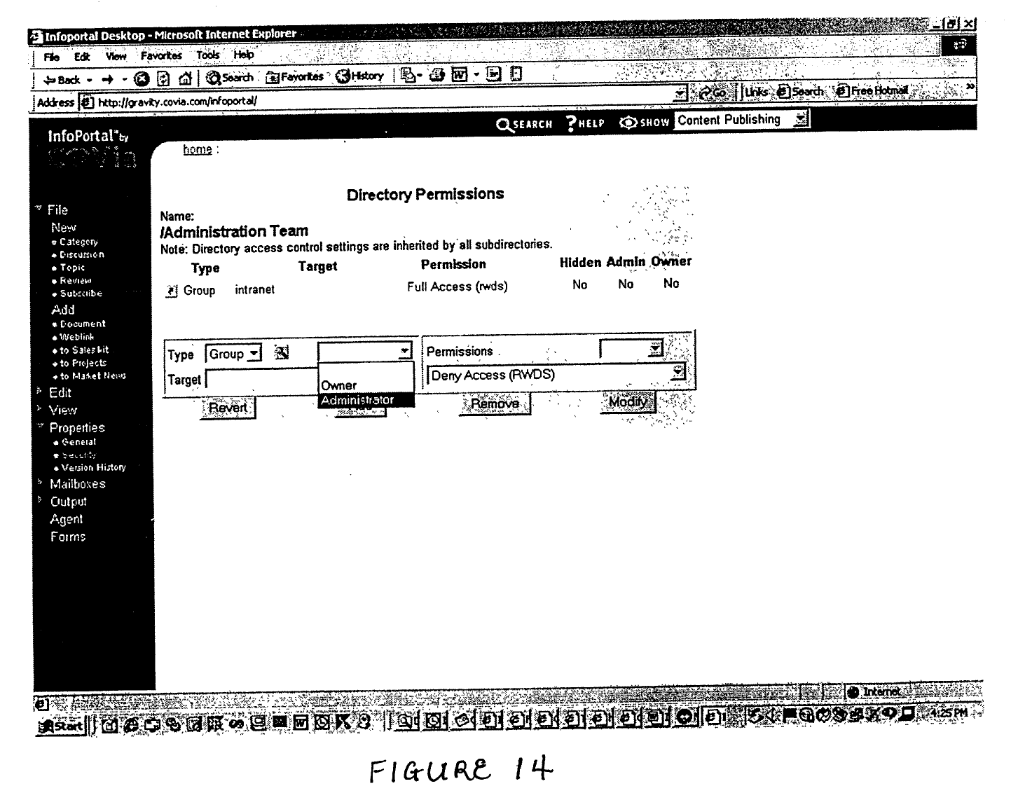

In an exemplary embodiment of the invention, Add Content 1502 may include options for a user to add folders, add documents, and add web links. Edit Content 1504 may include options for a user to cut, copy, paste, rename, delete, and convert content to PDF; Edit Content 1504 may also include an option for the user to convert content from Tiff to PDF. In an exemplary embodiment of the invention, Manage Content 1506 may include options allowing the user to, for example, create shortcuts, view content properties, perform access control, send content for review, check in and check out documents, view content version history, add notification options to content, view and edit notifications, and use agents to monitor content usage. It will be appreciated by one of ordinary skill in the art that modifications to the options shown may be made and that the options shown are exemplary in nature. In an exemplary embodiment of the invention, if the user clicks or selects Access Control 1508, a screen such as the one represented by the exemplary screenshot in FIG. 14 may be communicated to the user.

FIG. 14 shows an exemplary view of a directory permissions screen associated with an embodiment of the invention. For example, a user such as the owner of the node or an administrator may set permissions to view or edit a document, piece of content, resource, file, or data. In an embodiment, the user may set the permission level based on the user group. For example, the user may allow a first set of user groups read-only access to the document or content. The user may also allow a second set of user groups both read and write access to the document or content.

In an embodiment of the invention, for example, the user may select a document, a folder, or another piece of content and set it to “share” to be sent to all users of a selected group or to a selected subnode or set of subnodes. In an embodiment of the invention, the document, folder, or piece of content may also be set to optional.

Referring again to FIG. 5, Shared Document Repository Folder List 516 may include pointer arrays, for example, to document repository folders associated with a set of folders that may be inherited by or exposed to children or subnodes of the node.

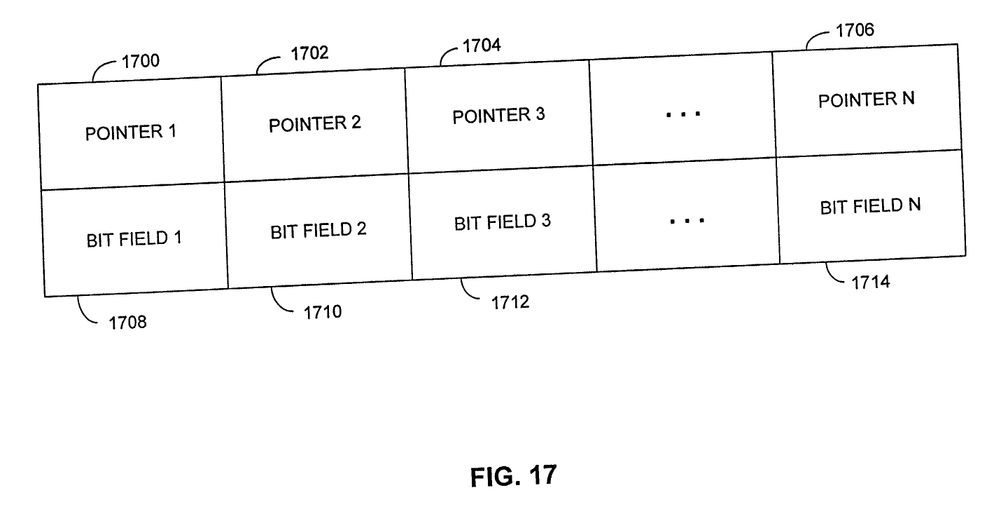

FIG. 17 shows an exemplary view of pointer array data structures stored in, for example, fields for an object such as but not limited to the exemplary object shown in FIG. 5. Referring to FIG. 17, a structure may include pointers 1700, 1702, 1704, and 1706. Each pointer may be associated with a bit field 1708, 1710, 1712, 1714 that may indicate whether, for example, a shared document, file, or folder is mandatory, optional, or unavailable. In an embodiment of the invention, FIG. 17 may also be associated with a data structure for an I Channel Pointer List.

Referring again to FIG. 5, Other Fields 518 may include other information associated with the node. In an embodiment of the invention, the script that is executed when a user logs on to a node may also use information stored in Other Fields 518 to create a view or display for the user. In an embodiment of the invention, Other Fields 518 may include, for example, information related to an interface or design selected by the user, information channels selected by the user and/or inherited by the node, a logo associated with the node, a client logo associated with the node, and other information selected by the user and inherited by the node.

In an embodiment of the invention, I Channel Pointer List 514 may include pointers or pointer arrays to information channels that are associated with the node. In an embodiment of the invention, a node may automatically inherit all information channels from the parent node to which it is associated. For each inherited information channel, the owner of the node or an administrator may set whether the information channel is mandatory, optional, or unavailable. In an embodiment of the invention, if the owner sets an information channel as mandatory, then all users may receive the information channel. If the owner sets an information channel as optional, then a user may select whether or not to display the information channel on the subnode. If the owner sets an information channel as unavailable, then users of the node may not receive or view the information channel.

In an embodiment of the invention, a user profile associated with the user contains information as to which if the information channels are available and may be viewed by the user. User profile information may be stored in, for example, User Preferences Table 608 in FIG. 6.

In an embodiment of the invention, documents and content associated with a node or object may be stored on a file system or in a document repository. In an embodiment of the invention, BNode information and other data associated with the BNode sites may be stored in a database. FIG. 6 shows an overview of a database 600 associated with an embodiment of the system and method of the present invention. Database 600 may also include BNode Object Table 602, User Object Table 604, Groups Table 606, and User Preferences Table 608.

BNode Object Table 602 may include, for example, a list of all objects or nodes created. In an embodiment of the invention, BNode Object Table 602 may include a dynamically growing number of BNode Objects shown in exemplary FIG. 5. In an embodiment of the invention, when a new node, site, or BNode Object is added to an embodiment of the invention, additional fields or entries are added to BNode Object Table 602.

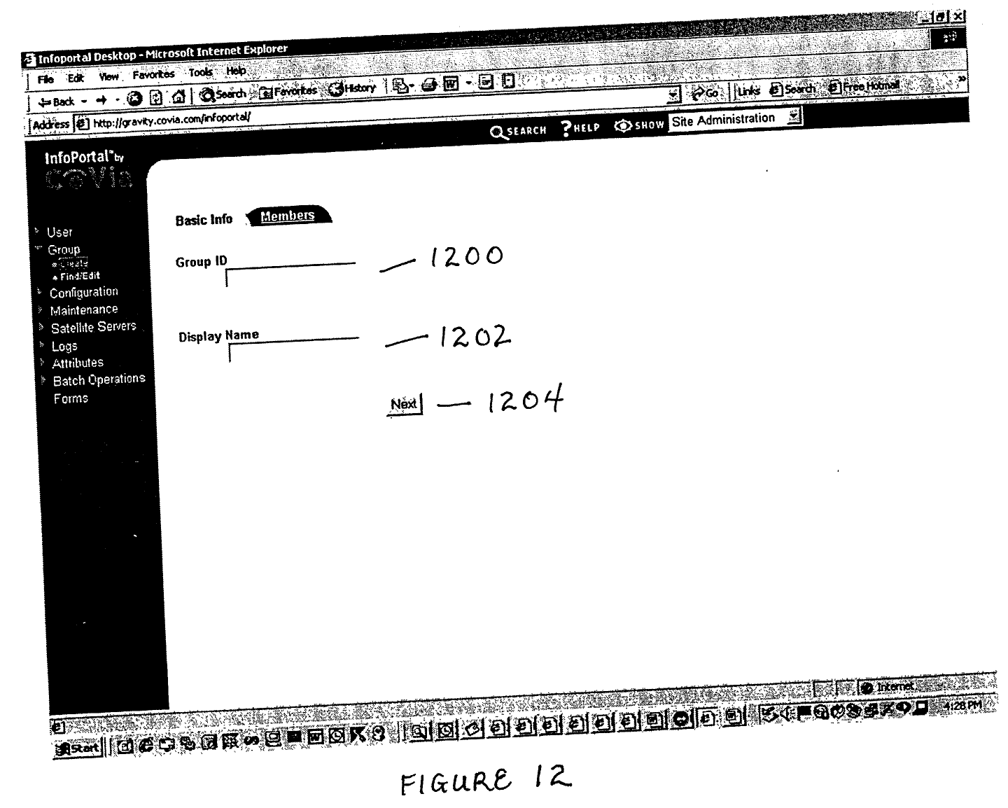

User Object Table 604 may include, for example, a list of all users, including administrators and other users, associated with an embodiment of the system and method of the present invention. Groups Table 606 may include, for example, a list of all groups associated with an embodiment of the system and method of the present invention. In an embodiment of the invention, the owner of a node or an administrator may create groups of users, such as through a screen shown by the exemplary screenshot in FIG. 12.

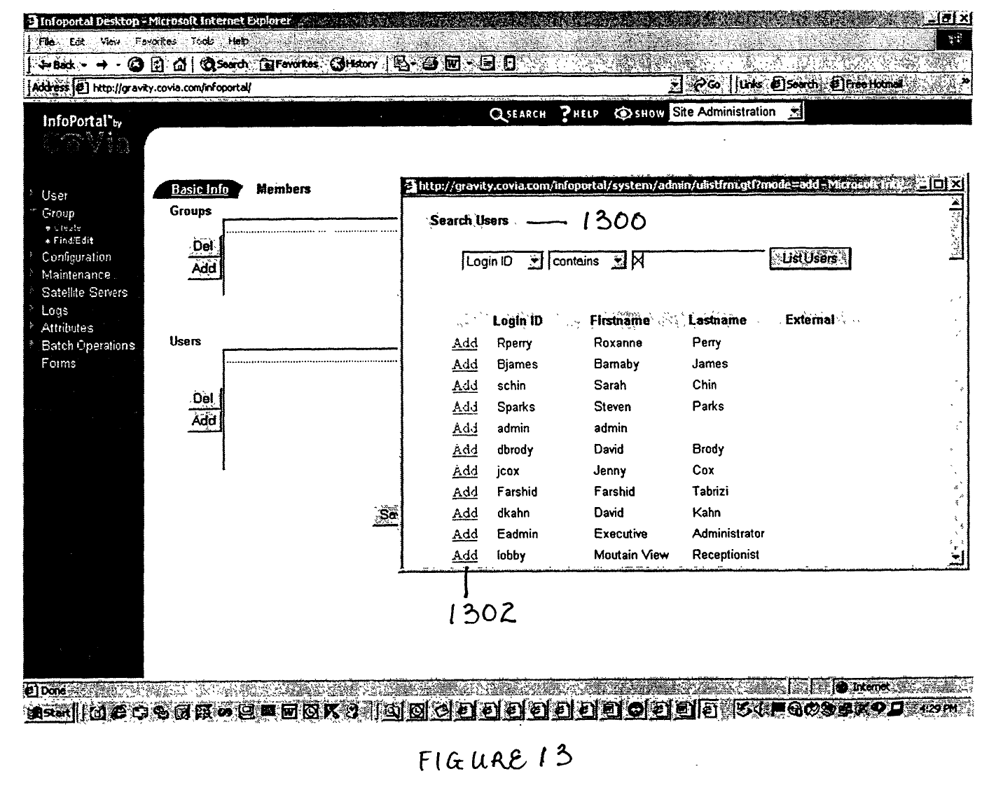

FIG. 12 shows an exemplary screenshot of a group management screen associated with an embodiment of the system and method of the present invention. From the group management screen, a user, such as an owner of a node or an administrator, may create, find, and edit groups of users. For example, a user creating a group may specify a Group ID 1200 and a name to be displayed 1202. Upon selecting a Group ID 1200 and a name to be displayed 1202, the user may click or select Next 1204 to enter the information. In an embodiment of the invention, a screen such as the one shown in the exemplary screenshot in FIG. 13 may then be displayed to the user.

FIG. 13 shows an exemplary screenshot of a user group management screen associated with an embodiment of the invention. From this screen, the user may Search Users 1300 to add to the created group or may Add Users 1302 from a list of all available users associated with a node. In an embodiment of the invention, when a subnode is created from a parent node, the subnode may inherit all of the users and groups that had previously been added to the parent node. In an embodiment of the invention, a user who creates a group or user at a node may select whether the group or user will be inherited in or passed to future subnodes.

In an embodiment of the invention, in addition to creating and managing groups, an embodiment of the system and method of the present invention also includes applications such as content management and document versioning.

Referring again to FIG. 6, User Preferences Table 608 may include, for example, information associated with the preferences or profiles for each user in User Object Table 604. In an embodiment of the invention, each object in BNode Object Table 602 may be linked to one or more users in User Object Table 604 who have permission to access the object. In an embodiment of the invention, each user in User Object Table 604 may be linked to a set of user preferences in User Preferences Table 608. Preferences associated with a user may include, for example, whether the user wishes to have email access, news updates, and/or sports news, along with the display format for the user. The display format may include choices involving graphical user interface designs, logos, and other information.

The following shows exemplary pseudocode for node, object, or site creation associated with an embodiment of the invention.

Create a node object

pcs createPCS( );

Collect User Information for PCS creator

userid=request.get(“userid”);

password=request.get(“password”);

data.put(“firstname”, request.get(“firstname”));

data.put(“lastname”, request.get(“lastname”));

data.put(“email”, request.get(“email”));

user=createUser(userid, password, data);

pcs.setOwner(user);

Name the Site

name=request.get(“pcsname”);

pcs.setName(name);

Select UI

theme=request.get(“theme”);

pcs.setTheme(theme);

Select Features

SubscribeFeatures(pcs, “World News, Sport News . . . ”);

Add Content

homeDir=CreateHomeDirectory(pcs);

homeDir.Allow(user, “a”); // a is admin privilege foo=homeDir.MakeDir(“Foo”);

Add members

userid=request.get(“userid”);

password=request.get(“password”);

data.put(“firstname”, request.get(“firstname”));

data.put(“lastname”, request.get(“lastname”));

data.put(“email”, request.get(“email”));

user=createUser(userid, password, data);

pcs. addMember(user);

Invite Member

users=pcs.getMembers( );

InviteUsers(users);

In an embodiment of the invention, referring again to FIG. 3, at step 314, a user may choose to create an object, such as a business node or a private client site, by, for example, connecting to a URL associated with the system and method of the present invention. At step 316, an embodiment of the system of the invention collects user information by prompting the user to enter information. This user information may include, for example, a username, a password, and user preferences.

In an embodiment of the invention, referring again to FIG. 6, exemplary user object fields associated with User Object Table 604 may include fields such as User Object ID, Firstname, Lastname, and Other Fields. In an embodiment of the invention, User Object ID may include, for example, a unique identifier associated with a user. Firstname may include a first name entered by the user. Lastname may include a last name entered by the user. Other Fields may include other fields having data associated with the user.

In an embodiment of the invention, User Preferences Table 608 may include fields such as Profile Object ID, Email, Timezone, Pwd, Address_{—}1, Address_{—}2, City, State, Zip, Country, Company, Title, Phone, and Other Fields. Profile Object ID may include, for example, a unique identifier associated with preferences for a user. Email may include an electronic mail address associated with the user. Timezone may include a time zone indicator associated with the user. Pwd may include a password selected for or by the user. Address_{—}1 may include a first address line associated with the user. Address_{—}2 may include a second address line associated with the user. City may include a city of personal or business residence associated with the user. State may include a state of the personal or business residence associated with the user. Zip may include a zip code of the personal or business residence associated with the user. Country may include a country or nation for the personal or business residence associated with the user. Company may include a company name associated with the user. Title may include a title or position associated with the user. Phone may include a telephone number associated with the user. Other Fields may include other fields having data associated with the user.

In an embodiment of the invention, Groups Table 606 may include fields such as Group Object ID, User Links, Group Name, Group Display Name, Group Permission Bits, and Other Fields. For example, Group Object ID may include a unique identifier for a group. User Links may include an array of pointers to one or more User Object IDs associated with users that are members of the group. Group Name may include, for example, an internal name for the group stored by an embodiment of the system and method of the present invention. Group Display Name may include, for example, a group name that is displayed to users when a user views the group. Group Permission Bits may include, for example, a permission bit for each pointer array in the User Links field. For example, Group Permission Bits may indicate whether a user in the group has read-only access, full editing access, or no access to information associated with the group.

Referring again to FIG. 3, at step 304, an embodiment of the system of the invention creates a user in a database associated with the system and marks the user that created the object, node, or site 314 as owner of the object, node, or site 314. In an embodiment of the invention, exemplary objects or sites 314 may include private client sites, sales sites, marketing sites, and support sites. In an embodiment of the invention, each site 314 may be further customized to suit the needs of the owner of the site 314. User information associated with the user may be stored in, for example, a user object table 604 in a database associated with an embodiment of the invention, as shown in exemplary FIG. 6. In an embodiment of the invention, an entry or field for a user saved in the database may contain a location associated with the node or site created or used by the user.

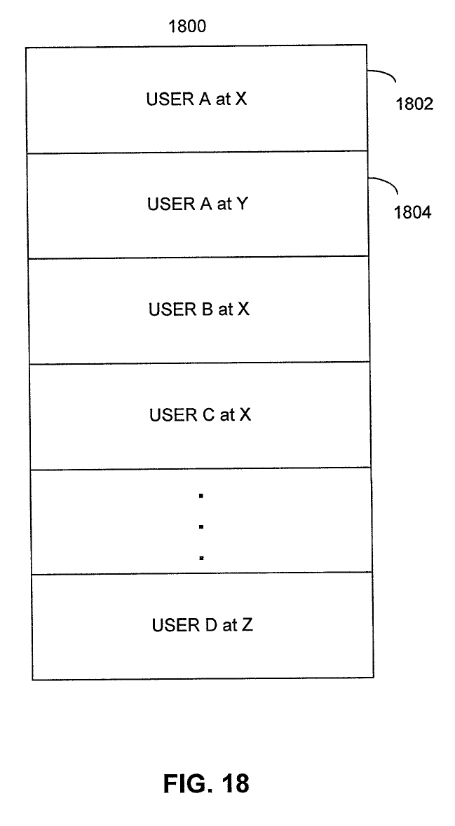

FIG. 18 shows an exemplary view of a global user table 1800 storing users associated with locations. For example, User A at location X 1802 may have the same username as User A at location Y 1804. User 1802 may log onto node X with the usemame A. User 1804 may log onto node Y with usemame A. Saving a user associated with a location in a global user table in the database is a novel embodiment of the invention that is not disclosed or suggested by prior art in the subject area.

In an embodiment of the invention, unlike in systems such as Yahoo.com, in which a user creates a unique user ID at registration that is stored in a global table, an embodiment of the present invention uses a hierarchy of nodes. In an embodiment of the invention, each node is associated with a user list for that node. In an embodiment of the invention, internally, User A at location X 1802 may be associated with a unique node ID that is different from the unique node ID associated with User A at location Y 1804, even though both users may use the same usemame, “A,” to log on to their respective nodes, sites, or objects.

Referring again to FIG. 3, in step 318, an embodiment of the system and method of the present invention prompts the user to name the node or site. After the user names the node, an embodiment of the system of the invention creates a blank site or node 306, the information for which may be stored in, for example, a table in an object database. In an embodiment of the invention, in step 300, a namespace associated with the user may be created in a user table associated with a database of an embodiment of the system and method of the present invention. In an embodiment of the invention, the namespace may include data such as a name associated with the user, a unique ID associated with the user, and a location associated with the user. For example, the location may be associated with the node or site at which the user logs on or gains access.

In an embodiment of the invention, a choice of user interfaces may be communicated to the user in step 320. Each of the user interfaces may be associated with a template. The user may select one of the user interfaces, and the template associated with the selected user interface may be associated with the node or site in step 308.

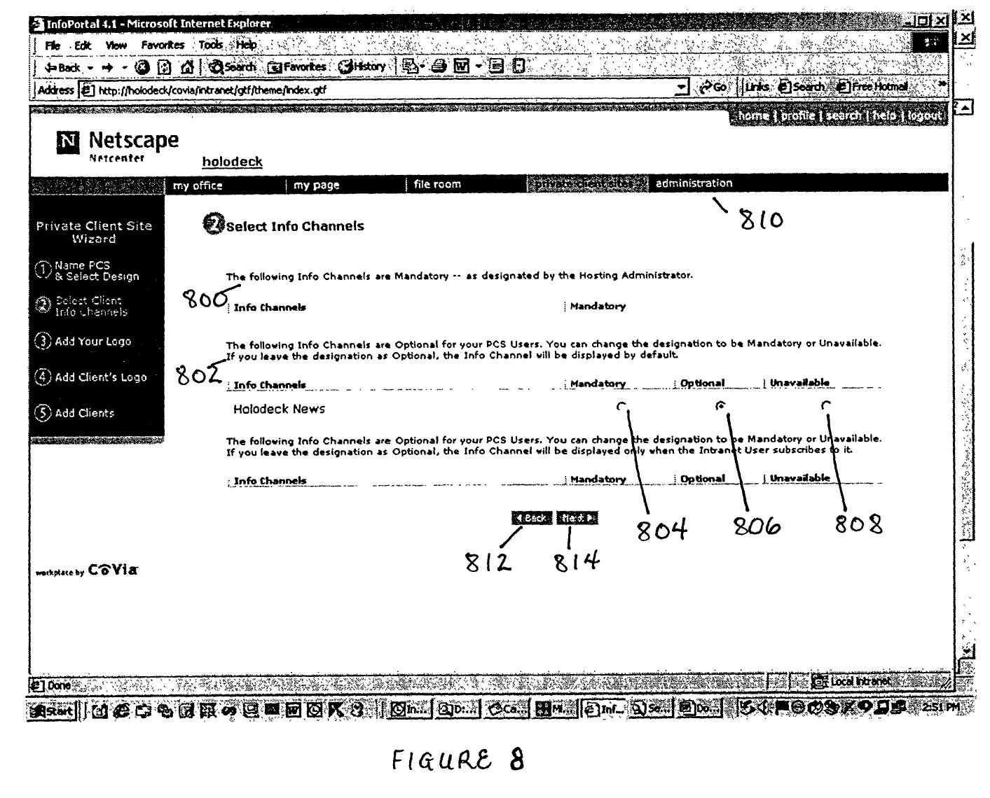

FIG. 7 shows an exemplary screenshot associated with a template selection screen that may be communicated to the user allowing the user to name the node or site 700 and select one of the designs or templates 702, 704, 706, 708. In this exemplary embodiment, the user may select, for instance, design or template 704. Upon clicking or selecting Next 710, a screen such as the one associated with the exemplary screenshot in FIG. 8 may be communicated to the user.

In an embodiment of the invention, referring again to FIG. 3, in step 322, the user may be prompted to select features to further customize the template, such as but not limited to a set of I-channels to which the user wishes to subscribe. After the user selects the features, the selections may be added to the templates in step 310. For instance, FIG. 8 shows an exemplary screenshot of an information channel selection screen associated with an embodiment of the system and method of the present invention. An embodiment of the invention displays to the user a list of mandatory information channels 800 and optional information channels 802. In an embodiment of the invention, the owner of the present node or site may accept mandatory information channels 800, which may have been selected by an owner or administrator of a parent node associated with the present node or site. In an embodiment of the invention, an information channel may include a bucket of information, such as but not limited to documents and links. In an embodiment of the invention, the information associated with an information channel may be related or categorized into subject areas. In an exemplary embodiment of the invention, a user may add content to an information channel and may start a flow of information in the information channel to other users. For example, in an embodiment, when a user adds content to an information channel, subscribers to the information channel may receive the content.

In an embodiment of the invention, the owner or an administrator of the present node or site may set each of the optional information channels 802 as mandatory 804, optional 806, or unavailable 808 for other users of the site. In an embodiment of the invention, the owner or administrator may set the status of each information channel at creation. The owner or administrator may also change the status of each information channel at any time after creation of the node by clicking or selecting, for example, an administration tab 810.

In an embodiment of the invention, if an information channel is set as mandatory 804, for example, other users of the node or site may automatically receive information from the information channel. In an embodiment of the invention, if the information channel is set as optional 806, other users of the node or site have the option to receive information from the information channel or to block information or unsubscribe from the information channel. If the information channel is set as unavailable 808, for example, other users of the node or site may not be receive information from the information channel.

In an embodiment of the invention, if a user sets an information channel as mandatory for a node, then all of the future children of the node also receive the information channel automatically as a mandatory information channel.

In an embodiment of the invention, referring again to FIG. 3, in step 322, the user may also select subscriptions to other features, such as but not limited to world news, sports news, instant messaging, and email.

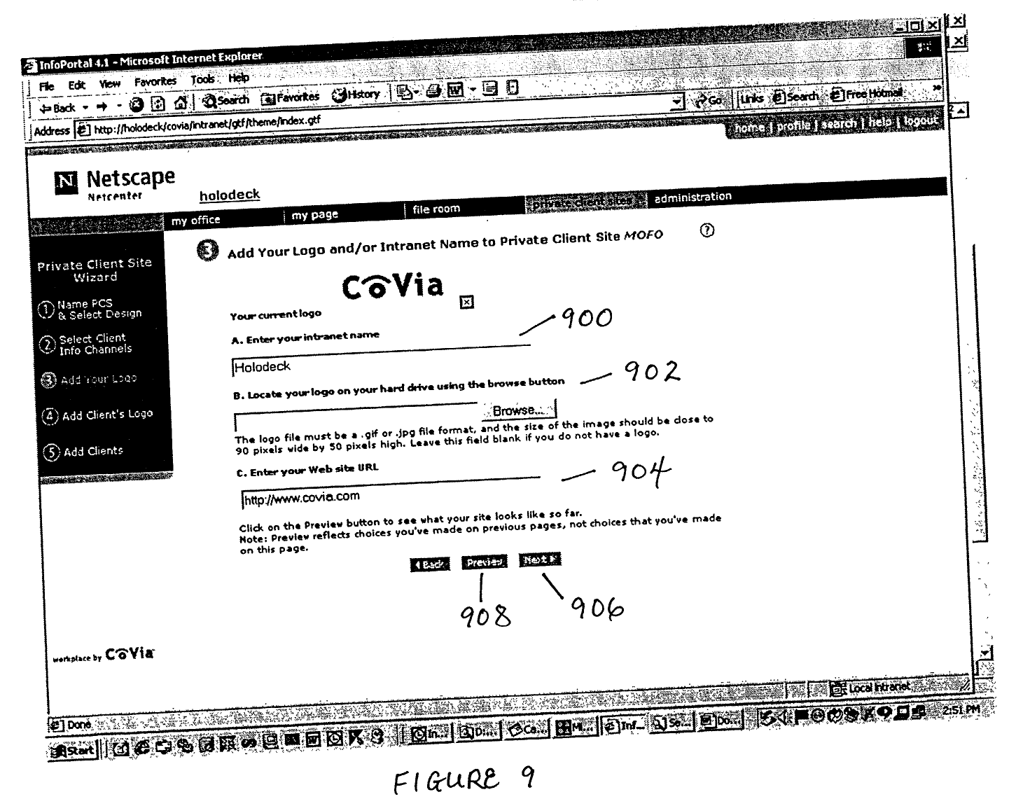

Referring again to FIG. 8, the user may select Back 812 to return to a previous screen associated with an embodiment of the invention. In an embodiment of the invention, if the user clicks or selects Next 814, a screen such as the one shown in the exemplary screenshot in FIG. 9 may be communicated to the user.

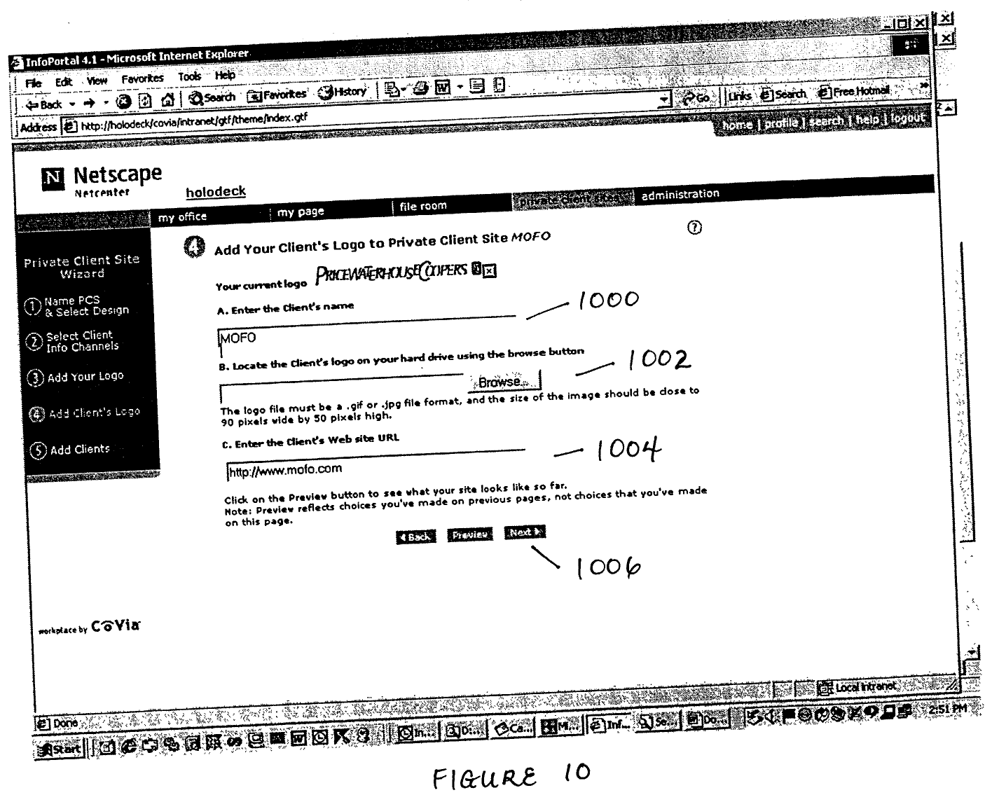

FIG. 9 shows a logo and intranet naming screen of an embodiment of the system and method of the present invention. In an embodiment of the invention, the user may enter or select an intranet name 900, a logo 902, and a web site name 904. In an exemplary embodiment of the invention, the user may type in an intranet name 900, select a logo 902 from a file on a local hard drive or system, and type in a web site URL 904. In an embodiment of the invention, if the user clicks or selects Preview 908, a preview screen showing a sample layout employing the user's entries from all previously accessed screens may be communicated to the user. If the user clicks or selects Next 906, a screen such as the one shown in the exemplary screenshot in FIG. 10 may be communicated to the user.

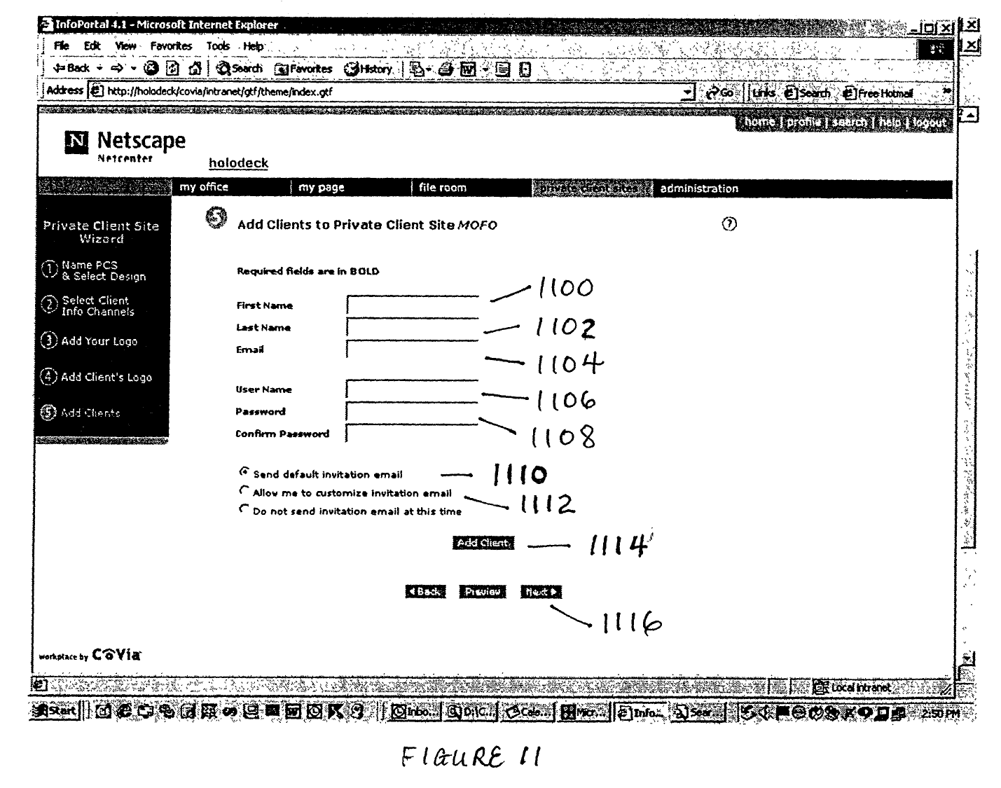

FIG. 10 shows an exemplary client name and logo screen associated with an embodiment of the system and method of the present invention. In an embodiment of the invention, an embodiment of the system and method of the present invention may prompt the user to select or enter a client name 1000, a client logo 1002, and a client web site URL 1004. If the user clicks or selects Next 1006, a screen such as the one shown in the exemplary screenshot in FIG. 11 may be communicated to the user.

FIG. 11 shows an exemplary screenshot of an add clients to private client site screen associated with an embodiment of the system and method of the present invention. In an embodiment of the invention, the present user may be prompted to enter a First Name 1100, Last Name 1102, and Email 1104 associated with a new user or client that the present user wishes to add to the site or node. The present user may also be prompted to select a User Name 1106 and Password 1108 for the new user to be added. In an embodiment of the invention, the present user may selected whether to send a default invitation email 1110 or a customized invitation email 1112 to the new user. If the present user clicks or selects Add Client 1114, an email containing, for example, the User Name 1106, Password 1108, and a web site URL link associated with a login screen for the node may be communicated to the email address of the new user entered at Email 1104.

In an embodiment of the invention, after clicking or selecting Add Client 1114, a blank screen such as the one shown in FIG. 11 may be communicated to the user to allow the user to add more clients or new users. When the user has finished adding new clients or users, the user may click or select Next 1116 to be shown a confirmation screen showing, for example, details associated with the newly created BNode object or site.

In an embodiment of the invention, referring again to FIG. 3, the system of an embodiment of the invention may then prompt the user to add content in step 324. The user may add content such as but not limited to files, documents, folders, notifications, database records, forms, instant messages, discussion lists, to do items, calendars, searches, agents, or other content. For example, the user may add content such as documents and folders in step 312 to the created node or site. The user may also be given the option to set security for the documents, folders, or other content in step 302.

In an embodiment of the invention, the system of an embodiment of the invention may communicate an add members screen to the user in step 326 to allow the user to add other users to the node or site by granting them access to the node or site. In an embodiment of the invention, after the user selects members to be invited in step 328, the system of an embodiment of the invention sends an email in step 336 to permit the recipients of the email to join the node or site. The email may contain, for example, a URL or other link that, when selected, takes the recipient to a page associated with the associated node or site. In an embodiment of the invention, each user added to the node or site in this way may be added to the user object table in the database associated with the system and method of the present invention. The system of an embodiment of the invention may mark each added user as an external user in the user object table, for example by saving the user as “external” in a field in the user object table. The node creation process may then complete at step 330.

In an embodiment of the invention, an embodiment of the system and method of the present invention may be used with, for example, a corporation that may already have a user database storing a list of users associated with the corporation. In an embodiment of the invention, an embodiment of the system and method of the present invention authenticates all of the users in the corporation database and permits these users to access the processes of an embodiment of the present invention. In an embodiment of the invention, at step 332, when a user creates a new private client site, collaboration site, node, or object and adds new users, the new users may be marked as “external” to prevent, for example, undesired alteration of the corporation's user database.

Referring again to FIG. 3, at step 334, the an embodiment of the system and method of the present invention allows added users to create additional nodes or sites as subnodes of the parent node created in step 314. In an embodiment of the invention, a subnode may have inherited characteristics of the associated parent node, such as but not limited to inherited information channels and their associated data structures. In an embodiment of the invention, additional subnodes associated with the present may be created at any other time by the owner of the node or by users of the present node.

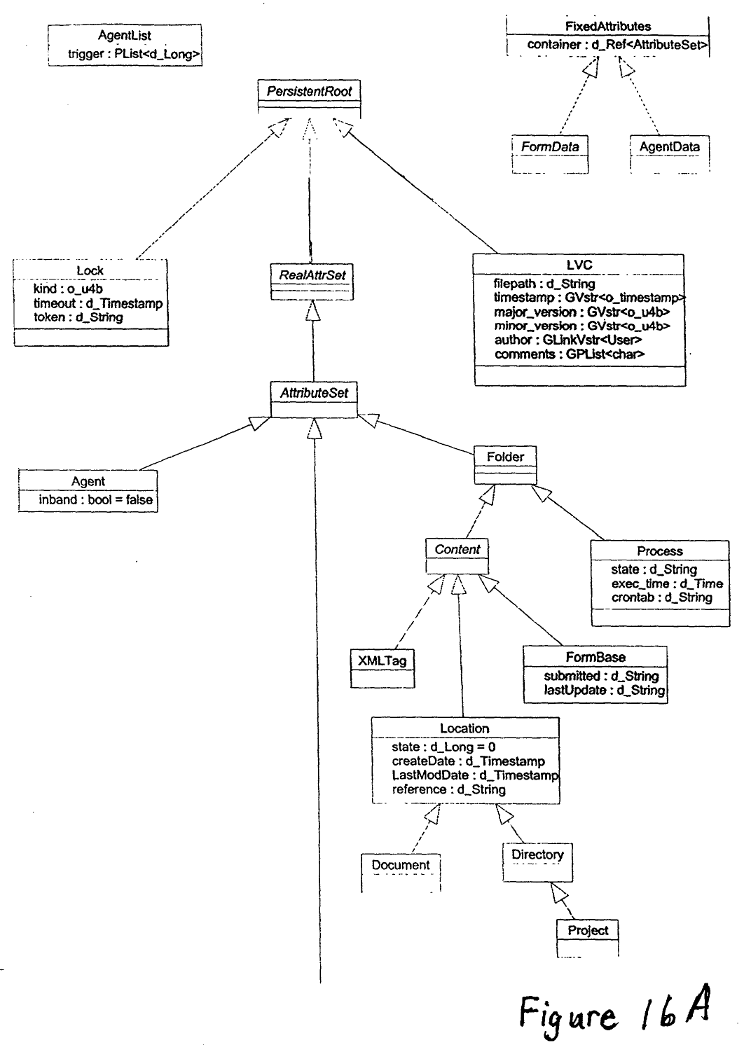

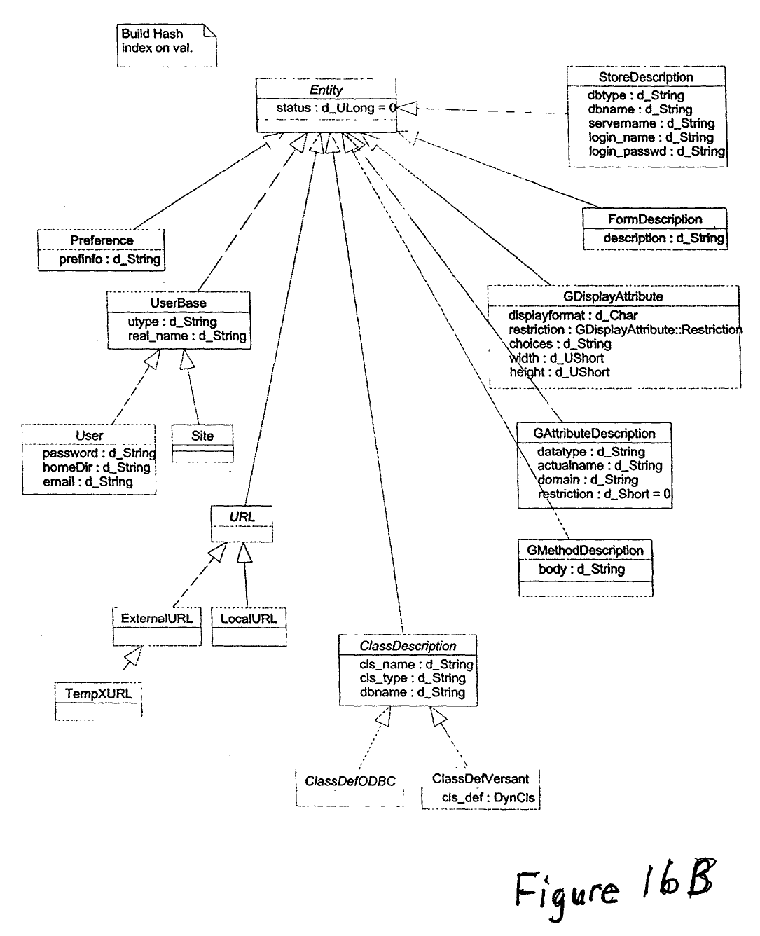

FIGS. 16A and 16B show an exemplary view of an object hierarchy for an embodiment of the system and method of the present invention. It will be appreciated by one of ordinary skill in the art that such an object hierarchy view is exemplary in nature and may be generated by a tool or application, such as Rational Rose or another visual modeling tool, that reads programming code and generates such an exemplary hierarchy.

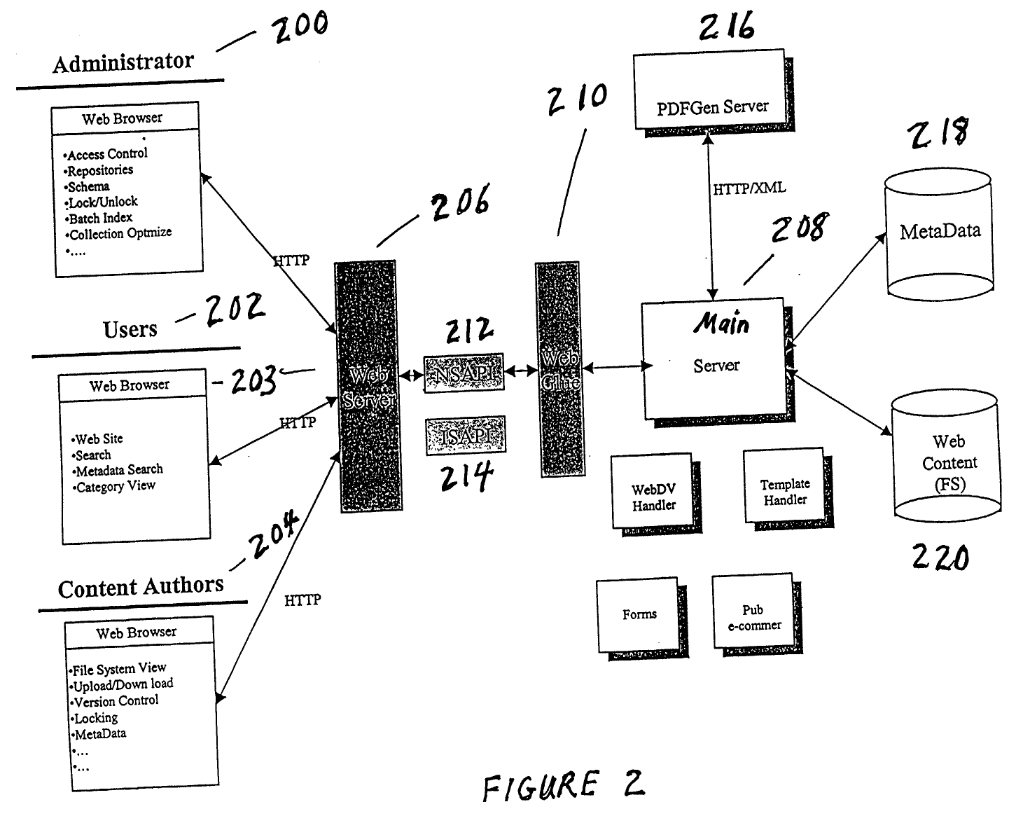

FIG. 2 shows an exemplary architecture overview associated with an embodiment of the system and method of the present invention. In an embodiment of the invention, an Administrator 200, User 202, or Content Author 204 may use Web Browser 203 to connect to Web Server 206 through, for example, an HTTP connection. In an exemplary embodiment of the invention, an Administrator 200, User 202, or Content Author 204 may enter a URL link on Web Browser 203, and the request may be sent to Web Server 206. In an embodiment of the invention, Web Server 206 may be, for example, licensed from a company such as Netscape or Microsoft and may contain a software development kit, such as NSAPI (Netscape Application Programming Interfaces) 212 or ISAPI (Internet Server Application Programming Interface) 214, to allow software developers to connect their software modules to Web Server 206. In an embodiment of the invention, Web Server 206 may pass the request to Main Server 208. In an embodiment of the invention, an embodiment of the system and method of the present invention may use Web Glue 210 to patch information between the front end server and the back end server or to connect or translate information between Web Server 206 and Main Server 208.

In an embodiment of the invention, the hardware associated with an embodiment of the system and method of the present invention may be run either on, for example, one machine, in a standalone architecture. In a stand-alone configuration, for example, an Intel processor may run Web Server 206 Main Server 208, and PDFGen Server 216 on a standalone personal computer or CPU. In another embodiment of the invention, the hardware may also be run on, for example multiple machines, in a cluster architecture. In a cluster architecture, for instance, an embodiment of the system and method of the present invention may employ a load balancer to determine which of the machines or computers is best prepared to handle each request, for example by checking the free memory available for each computer.

In an embodiment of the invention, PDFGen server is a server that communicates with Main Server 208 and converts documents to the PDF file format. In an embodiment of the invention, a user may, for example, upload a document of any type, such as but not limited to a PDF file or a Microsoft Word document and may associate MetaData 218 or other attributes to that document. For example, a user may upload a gif, jpeg, or other graphic file that may not itself be searchable. In an embodiment of the invention, the user may then describe the characteristics of the graphic file for reference, such as a written description or a description of the resolution, for example 72 dpi, and may be stored as MetaData 218 associated with the file that is stored in a database associated with Main Server 208. In an embodiment of the invention, the MetaData may be searchable or otherwise customized. In an embodiment of the invention, an embodiment of the system and method of the present invention may also store Web Content 220 in a file system (FS) associated with Main Server 208.

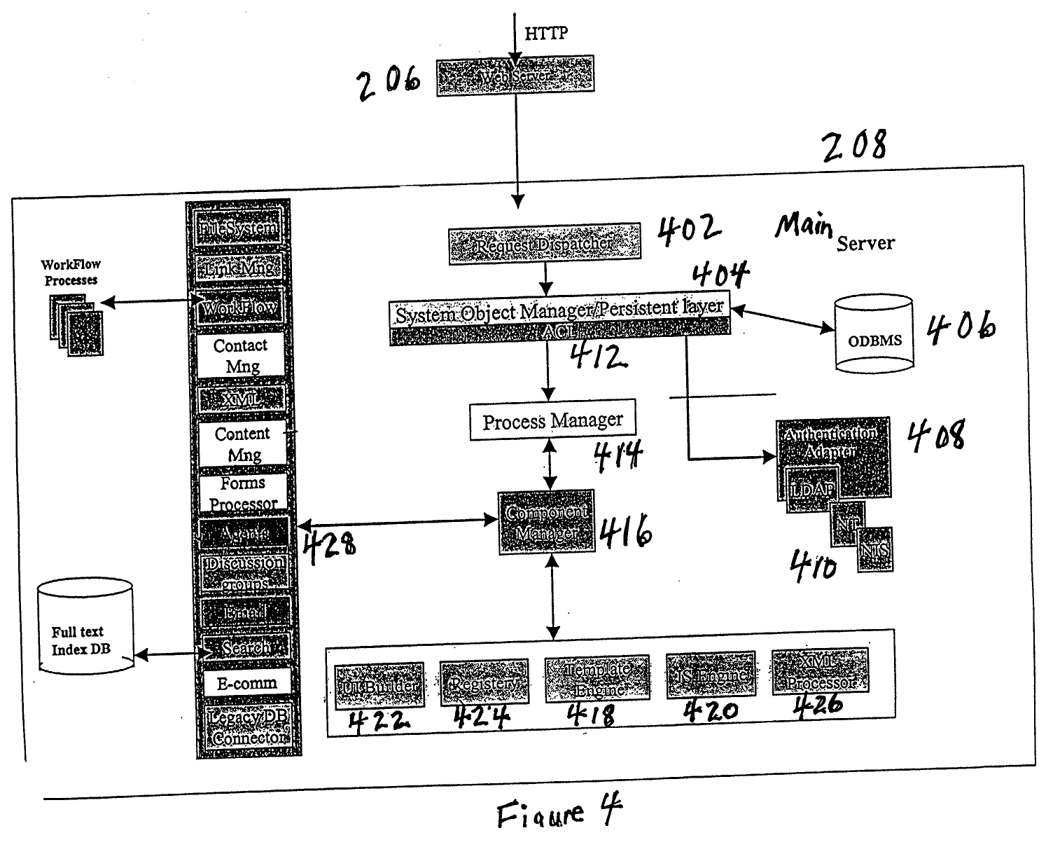

FIG. 4 shows an exemplary view of Main Server 208 associated with an embodiment of the system and method of the present invention. In an embodiment of the invention, an HTTP request may be received by Web Server 206. The request may be passed to Main Server 208 to Request Dispatcher 402 or another module. In an embodiment of the invention, an embodiment of the system and method of the present invention determines a URL associated with the request, obtains authentication information, and routes the request to a subsystem based on this information. For example, System Object Manager 404 may examine the URL and the authentication information, search for and retrieve an associated user object from ODBMS (Object Database Management System) 406 along with a resource object that represents the URL target. In an embodiment of the invention, ACL (Access Control List) Manager 412 may call Authentication Adapter 408 to determine whether the user associated with the request is a valid user. In an embodiment of the invention, System Object Manager 404 may contact, for example, ODBMS 406 to retrieve objects and information associated with the user. In an embodiment of the invention, outside authentication services 410, such as LDAP, NT, and NIS, may be used to authenticate the user.

In an embodiment of the invention, an embodiment of the system and method of the present invention also verifies, for example, through ACL Manager 412, that the user has permission to access the object, based on the URL link associated with the request and information associated with the user. For example, the user may be prompted to type in a username and password.

In an embodiment of the invention, Process Manager 414 may, through Component Manager 416, contact Template Engine to retrieve a template file, which may include a script, to process and draw an visual interface for display to the user. In an embodiment of the invention, Javascript Engine 420 may execute JAVA script codes associated with the template file. In an embodiment of the invention, User Interface Builder 422 may create elements of the user interface.

In an embodiment of the invention, Registry 424 may store global information, such as but not limited to static text that appears on pages associated with various user interfaces. In an exemplary embodiment of the invention, XML Processor 426 may be used to process requests that are in XML format and to pass information between modules associated with an embodiment of the system and method of the present invention.

In an embodiment of the invention, Component Manager 416 may run Agents 428 associated with an embodiment of the system and method of the present invention. An exemplary Agent 428 may monitor whether certain pages are viewed by certain users. For example, the Agent may automatically notify user A whenever user B logs onto the site, views a page, or downloads a document.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather is to be defined by the appended claims.

What is claimed is:

1. A method of creating an object, comprising:
communicating one or more site design choices for display to a user;
receiving a selection of one of the one or more site designs choices;
communicating one or more information channel choices for display to the user; and
receiving a selection associated with at least one of the one or more information channel choices.

2. The method of claim 1, wherein the object is a node or a site.

3. The method of claim 1, further comprising:
prompting the user to communicate at least one member selected from the group consisting of an intranet name, an address associated with a logo file, a web site URL, a client name, an address associated with a client logo file, and a client web site URL.

4. The method of claim 3, wherein the logo file is associated with a format, where in the format is at least one member selected from the group consisting of a.gif file format and a .jpg file format.

5. The method of claim 1, further comprising:
prompting the user to communicate a data associated with a client, wherein the data includes at least one member selected from the group consisting of a client first name, a client last name, a client email, a user name, and a password.

6. The method of claim 1, further comprising:
creating one or more fields associated with the object, wherein the one or more fields include data.

7. The method of claim 6, wherein the data includes at least one member selected from the group consisting of a node ID associated with the object, a name associated with the object, a list of one or more parent nodes associated with the object, a list of one or more subnodes associated with the object, a link associated with one or more users, a link to a view or template, a permissions field, a link associated with a document repository, an information channel pointer list, a shared document repository folder list, and other fields.

8. The method of claim 7, further comprising creating one or more links associated with the one or more subnodes.

9. The method of claim 7, wherein the one or more users have access to log onto the object.

10. The method of claim 7, wherein the view or template contains information associated with a user profile associated with the user.

11. The method of claim 10, wherein the information associated with a user profile includes at least one member selected from the group consisting of a user interface and one or more visual objects.

12. The method of claim 7, wherein the document repository contains at least one member selected from the group consisting of a document, a file, and a piece of content.

13. The method of claim 1, wherein the object is associated with a database, wherein the database contains at least one member selected from the group consisting of an object table, a user table, a groups table, and a user preferences table.

14. A data structure comprising:
at least one identification field associated with a user, wherein the identification field includes a user name and a location associated with the user, wherein the location is associated with at least one member selected from the group consisting of an object, a node, or a site.

15. The data structure of claim 14, wherein the data structure is associated with a global user table.

16. A method of creating an object, comprising:
receiving user information;
creating a name associated with the object;
communicating a choice of one or more user interfaces;
receiving a selection of one of the one or more user interfaces;
communicating a set of one or more feature choices; and
receiving a selection associated with at least one of the one or more feature choices.

17. The method of claim 16, wherein the object is a node or site.

18. The method of claim 16, further comprising:
communicating an invitation to an external user, wherein the invitation is associated with the object.

19. The method of claim 16, further comprising:
adding user data to a table, wherein the table is associated with a database, and wherein the user data is associated with the user information.

20. The method of claim 16, wherein the user information includes a name associated with a user, further comprising:
creating a namespace in a user table, wherein the namespace is associated with the name.

21. The method of claim 16, wherein the user information is associated with a user, further comprising:
marking the user as an owner associated with the object.

22. A computer program product for use with a system for creating an object, said computer program product comprising:
a computer useable medium including computer readable program code means embodied in said medium for causing creating the object, said computer program product including:
(a) computer readable program code means for causing a computer to effect communicating one or more site design choices for display to a user;
(b) computer readable program code means for causing the computer to receive a selection of one of the one or more site designs choices;
(c) computer readable program code means for causing the computer to communicate one or more information channel choices for display to the user; and
(d) computer readable program code means for causing the computer to receive a selection associated with at least one of the one or more information channel choices.

23. An article of manufacture comprising:
a computer useable medium including computer readable program code embodied therein for causing creating an object, the computer readable program code in said article of manufacture comprising:
(a) computer readable program code means for causing a computer to effect communicating one or more site design choices for display to a user;
(b) computer readable program code means for causing the computer to receive a selection of one of the one or more site designs choices;
(c) computer readable program code means for causing the computer to communicate one or more information channel choices for display to the user; and
(d) computer readable program code means for causing the computer to receive a selection associated with at least one of the one or more information channel choices.

24. The computer program product of claim 22, wherein the object is a node or a site.

25. The article of manufacture of claim 23, wherein the object is a node or a site.

26. The computer program product of claim 22, further comprising:
computer readable program code means for causing the computer to prompt the user to communicate at least one member selected from the group consisting of an intranet name, an address associated with a logo file, a web site URL, a client name, an address associated with a client logo file, and a client web site URL.

27. The article of manufacture of claim 23, further comprising:
computer readable program code means for causing the computer to prompt the user to communicate at least one member selected from the group consisting of an intranet name, an address associated with a logo file, a web site URL, a client name, an address associated with a client logo file, and a client web site URL.

28. The computer program product of claim 22, further comprising:
computer readable program code means for causing the computer to create one or more fields associated with the object, wherein the one or more fields include data.

29. The article of manufacture of claim 23, further comprising:
computer readable program code means for causing the computer to create one or more fields associated with the object, wherein the one or more fields include data.

30. The computer program product of claim 28, wherein the data includes at least one member selected from the group consisting of a node ID associated with the object, a name associated with the object, a list of one or more parent nodes associated with the object, a list of one or more subnodes associated with the object, a link associated with one or more users, a link to a view or template, a permissions field, a link associated with a document repository, an information channel pointer list, a shared document repository folder list, and other fields.

31. The article of manufacture of claim 29, wherein the data includes at least one member selected from the group consisting of a node ID associated with the object, a name associated with the object, a list of one or more parent nodes associated with the object, a list of one or more subnodes associated with the object, a link associated with one or more users, a link to a view or template, a permissions field, a link associated with a document repository, an information channel pointer list, a shared document repository folder list, and other fields.

32. A computer program product for use with a system for creating an object, said computer program product comprising:
a computer useable medium including computer readable program code means embodied in said medium for causing creating the object, said computer program product including:
(a) computer readable program code means for causing a computer to effect receiving user information;
(b) computer readable program code means for causing the computer to create a name associated with the object;
(c) computer readable program code means for causing the computer to communicate a choice of one or more user interfaces;
(d) computer readable program code means for causing the computer to receive a selection of one of the one or more user interfaces;
(e) computer readable program code means for causing the computer to communicate a set of one or more feature choices; and
(f) computer readable program code means for causing the computer to receive a selection associated with at least one of the one or more feature choices.

33. An article of manufacture comprising:
a computer useable medium including computer readable program code embodied therein for causing creating an object, the computer readable program code in said article of manufacture comprising:
(a) computer readable program code means for causing a computer to effect receiving user information;
(b) computer readable program code means for causing the computer to create a name associated with the object;
(c) computer readable program code means for causing the computer to communicate a choice of one or more user interfaces;
(d) computer readable program code means for causing the computer to receive a selection of one of the one or more user interfaces;
(e) computer readable program code means for causing the computer to communicate a set of one or more feature choices; and
(f) computer readable program code means for causing the computer to receive a selection associated with at least one of the one or more feature choices.

34. The computer program product of claim 32, wherein the object is a node or a site.

35. The article of manufacture of claim 33, wherein the object is a node or a site.

36. The computer program product of claim 32, further comprising:
computer readable program code means for causing the computer to communicate an invitation to an external user, wherein the invitation is associated with the object.

37. The article of manufacture of claim 33, further comprising:
computer readable program code means for causing the computer to communicate an invitation to an external user, wherein the invitation is associated with the object.

38. The computer program product of claim 32, further comprising:
computer readable program code means for causing the computer to add user data to a table, wherein the table is associated with a database, and wherein the user data is associated with the user information.

39. The article of manufacture of claim 33, further comprising:
computer readable program code means for causing the computer to add user data to a table, wherein the table is associated with a database, and wherein the user data is associated with the user information.

40. A method of creating and managing a network of objects comprising:
creating a first object, wherein the first object is associated with a first URL or web site;
creating a first table associated with the first object;
creating a second object, wherein the second object is associated with a second URL or web site;
creating a second table associated with the second object;
creating a parent list associated with the second table, wherein the parent list includes at least one array of pointers to at least one parent object, wherein the at least one parent object includes the first object;
creating a subnode list associated with the first object, wherein the subnode list includes at least one array of pointers to at least one subnode object, wherein the at least one subnode object includes the second object.

41. The method of claim 40, wherein the first object is a node or site, and wherein the second object is a node or site.

42. The method of claim 40, wherein the first object is an author site or a collaboration site, and wherein the second object is a collaboration site or a private client site.

43. The method of claim 40, further comprising communicating content from the first object to the second object.

44. The method of claim 41, wherein the content includes at least one member selected from the group consisting of a file, a folder, a document, an email, an instant message, a notification, a database record, and a link.

45. The method of claim 40, wherein the first object is associated with at least one information channel, further comprising:
creating a subscription to the at least one information channel, wherein the subscription is associated with the second object.

46. The method of claim 45, wherein the at least one information channel includes at least one mandatory information channel.

47. The method of claim 45, wherein the at least one information channel includes at least one optional information channel.

48. The method of claim 47, further comprising:
receiving a selection associated with the at least one optional information channel, wherein the selection includes at least one member selected from the group consisting of mandatory, optional, and unavailable.

49. The method of claim 40, further comprising:
associating a first user to the first object, wherein the first user is at least one member selected from the group consisting of an administrator, an employee, an external user, and a group.

50. The method of claim 49, further comprising:
associating a second user to the first object, wherein the second user is at least one member selected from the group consisting of an administrator, an employee, an external user, and a group.

51. The method of claim 49, wherein the first user is an administrator, further comprising:
creating a permission field associated with the first table; and
creating a pointer array associated with the permission field;
creating a bit field associated with the pointer array; and
setting the bit field to a number, wherein the number is associated with full access.

52. The method of claim 49, wherein the first user is an employee, further comprising:
creating a permission field associated with the first table; and
creating a pointer array associated with the permission field;
creating a bit field associated with the pointer array; and
setting the bit field to a number, wherein the number is associated with read-only access.

53. The method of claim 40, wherein the objects are collaboration sites.

54. A computer program product for use with a system for creating and managing a network of objects, said computer program product comprising:
a computer useable medium including computer readable program code means embodied in said medium for causing creating the network of objects, said computer program product including:
(a) computer readable program code means for causing a computer to effect creating a first object, wherein the first object is associated with a first URL or web site;
(b) computer readable program code means for causing the computer to create a first table associated with the first object;
(c) computer readable program code means for causing the computer to create a second object, wherein the second object is associated with a second URL or web site;
(d) computer readable program code means for causing the computer to create a second table associated with the second object;
(e) computer readable program code means for causing the computer to create a parent list associated with the second table, wherein the parent list includes at least one array of pointers to at least one parent object, wherein the at least one parent object includes the first object; and
(f) computer readable program code means for causing the computer to create a subnode list associated with the first object, wherein the subnode list includes at least one array of pointers to at least one subnode object, wherein the at least one subnode object includes the second object.

55. An article of manufacture comprising:
a computer useable medium including computer readable program code embodied therein for causing creating and managing a network of objects, the computer readable program code in said article of manufacture comprising:
(a) computer readable program code means for causing a computer to effect creating a first object, wherein the first object is associated with a first URL or web site;
(b) computer readable program code means for causing the computer to create a first table associated with the first object;
(c) computer readable program code means for causing the computer to create a second object, wherein the second object is associated with a second URL or web site;
(d) computer readable program code means for causing the computer to create a second table associated with the second object;
(e) computer readable program code means for causing the computer to create a parent list associated with the second table, wherein the parent list includes at least one array of pointers to at least one parent object, wherein the at least one parent object includes the first object; and
(f) computer readable program code means for causing the computer to create a subnode list associated with the first object, wherein the subnode list includes at least one array of pointers to at least one subnode object, wherein the at least one subnode object includes the second object.

56. The method of claim 40, wherein the first object is associated with at least one view or template.

57. The method of claim 56, wherein the second object is associated with at least one view or template.
